(19) United States
(12) Patent Application Publication
(10) Pub. No.: US 2009/0196950 A1
(43) Pub. Date: Aug. 6, 2009

(54) METHODS OF FEEDING PIGS AND PRODUCTS COMPRISING BENEFICIAL FATTY ACIDS

(75) Inventors: Gary F. Hartnell, St. Peters, MO (US); Virginia M. Ursin, Pawcatuk, CT (US); Donald M. Lucas, Wildwood, MO (US)

Correspondence Address: Armstrong Teasdale LLP (29135);Christopher M. Goff, One Metropolitan Square, Suite 2600, St. Louis, MO, 63102-2740, US

(73) Assignee: Monsanto Company, St. Louis, MO (US)

(21) Appl. No.: 12/362,102

(22) Filed: Jan. 29, 2009

Related U.S. Application Data
(60) Provisional application No. 61/062,785, filed on Jan. 29, 2008.

(51) Int. Cl. A23L 1/314; A23K 1/18

(52) U.S. Cl. 426/2; 426/645

(57) ABSTRACT

The present invention provides for improved pork products for human consumption and methods of producing such pork products by incorporating healthy lipids containing stearidonic acid into swine feed products. Furthermore, the present invention provides methods for producing said products. In one embodiment of the invention, an animal may be fed feed comprising a transgenic plant product. In other embodiments of the invention, pork meat products for human consumption, such meat products comprising SDA, EPA, and DHA are disclosed. In further embodiments of the invention, pork products comprising novel fatty acid profiles are disclosed.

### CROSS REFERENCE TO RELATED APPLICATIONS

This patent application claims priority from U.S. Provisional Patent Application 61/062,785 filed on Jan. 29, 2008, the entire contents of which is incorporated herein by reference.

### FIELD OF THE INVENTION

The invention relates to the enhancement of desirable characteristics in pigs and/or pork products through the incorporation of beneficial fatty acids in animal feed or in animal feed supplements. More specifically, it relates to methods of production and processing of pork products comprising polyunsaturated fatty acids including stearidonic acid.

### BACKGROUND OF THE INVENTION

The present invention is directed to a method for improving swine tissues or the meat produced there from as a human food source through the utilization of plant-derived stearidonic acid (“SDA”) or SDA oil as a component in animal feed. Specifically, the inventors provide techniques and methods for the utilization of transgenic plant-derived SDA compositions in feed products that improve the nutritional quality of pork products or in the productivity of the animals themselves for later human consumption.

Many studies have made a physiological link between dietary fats and pathologies such obesity and atherosclerosis in humans. In some instances, human consumption of dietary fats has been discouraged by the medical establishment. Pork products such as bacon and ham are frequently considered to have deleterious effects on human health due to their relatively high concentrations of saturated animal fats. More recently, the qualitative differences existing between dietary fats and their corresponding health benefits for consumers have begun to be recognized by physicians and nutritionists.

Recent studies have determined that despite their relatively simple biological structures there are some types of fats that, when consumed by humans, improve physiological function in some ways and that may, in fact, be essential to certain physiological processes. The wider class of fat molecules includes fatty acids, isoprenols, steroids, other lipids and oil-soluble vitamins. Among these are the fatty acids. The fatty acids are carboxylic acids, which have from 2 to 26 carbon atoms in their molecular “backbone,” with few desaturated sites in their carbohydrate structure, many being fully hydrogenated. They generally have dissociation constants (pKa's) of about 4.5 indicating that in normal human physiological conditions (Es: normal human physiological pH is about 7.4) the vast majority will be in a dissociated form.

With continued experimentation researchers have begun to understand the nutritional need for fats and in particular fatty acids in the human diet. For this reason, many in the food industry have begun to focus on providing the optimal fatty acid and lipid profiles in the production of food, with its consequent benefits for the animals consuming the modified feed and in products derived from those animals for human consumption. This focus has been particularly intense for the production and incorporation of Omega-3 fatty acids into the diet.

Omega-3 fatty acids are long-chain polyunsaturated fatty acids (18-22 carbon atoms in chain length) with the first of the double bonds (“unsaturations”) beginning with the third carbon atom from the methyl end of the molecule. They are called “polyunsaturated” because their molecules have two or more double bonds “unsaturations” in their carbohydrate chain. They are termed “long-chain” fatty acids since their carbon backbone has at least 18 carbon atoms. In addition to stearidonic acid “SDA” the omega-3 family of fatty acids includes alpha-linolenic acid (“ALA”), eicosatetraenoic acid (ETA), eicosapentaenoic acid (“EPA”), docosapentaenoic acid (DPA), and docosahexaenoic acid (“DHA”). ALA can be considered a “base” omega-3 fatty acid, from which EPA and DHA are made in the body through a series of enzymatic reactions, including the production of SDA. Most nutritionists point to DHA and EPA as the most physiologically important of the Omega-3 fatty acids with the most beneficial effects. However, SDA has also been shown to have significant health benefits. See for example, U.S. Pat. No. 7,163,960 herein incorporated by reference.

The biosynthetic pathway from ALA to longer chain fatty acids is called “elongation” (the molecule becomes longer by incorporating new carbon atoms) and “desaturation” (new double bonds are created), respectively. In nature, ALA is primarily found in certain plant leaves and seeds (e.g., flax) while EPA and DHA mostly occur in the tissues of cold-water predatory fish (e.g., tuna, trout, sardines and salmon), originating from the marine algae or microbes that they feed upon.

Along with the movement of food companies to develop and deliver essential fats and oils as an important components in a healthy human diet, governments have begun developing regulations pushing for the adoption of PUFA's in the diet. The difficulty in supplying these needs has been the inability to develop a large enough supply of Omega-3 oil to meet growing marketplace demand. As already mentioned, the Omega-3 fatty acids commercially deemed to be of highest value, EPA and DHA, also chemically oxidize very quickly over time limiting commercial availability and durability. Importantly, during the rapid process of EPA and DHA degradation these long chain fatty acids develop rancid and profoundly unsatisfactory sensory properties that make their inclusion in many foodstuffs difficult or impossible from a commercial acceptance perspective. In addition, with increased demand for Omega-3 fatty acids has come the realization that already depleted global fish stocks cannot meet any significant growth in future human nutritional needs for Omega-3's. These limitations on supply, durability, stability and sourcing greatly increase cost and correspondingly limit the availability of dietary Omega-3's.

In addition, sub-optimal nutrition is a limiting factor in animal productivity and reproduction. Basic information regarding these processes in agriculturally important animals, including common commercial swine, is lacking. New knowledge in these areas is needed to improve animal health and fitness, reproductive performance, productivity (i.e., rate of production of an animal product such as milk, meat, or eggs), product composition (e.g., meat composition), quality (e.g., meat quality), and a feed amount per unit of animal weight gain basis.

Metabolic modifiers, such as certain fatty acids, are a group of compounds that modify animal metabolism in specific and directed ways if provided in the diet. Metabolic modifiers generally have the overall effect of improving productive efficiency (weight gain or milk yield per feed unit), improving carcass composition (meat-to-fat ratio and/or marbling) in growing animals, increasing milk yield in lactating animals and decreasing animal waste. Prior research has indicated that supplementation with certain dietary fatty acids, acting as metabolic modifiers, can enhance animal productivity (Calder (2002); Klasing (2000); and, Mattos (2000)).

Accordingly a need exists to enhance and optimize the productivity of livestock animals. The feed compositions of the current invention comprise SDA compositions that can be used in producing an enhanced feed for pigs containing the SDA compositions of the invention.

In addition, a need exists to provide a consumer acceptable means of delivering EPA and DHA or critical precursors in food formulations in a commercially acceptable way. The current invention provides an alternative to fish or microbe supplied Omega-3 fatty acids in the form of pork meat comprising beneficial acids and does so utilizing a comparatively chemically stable fatty acid, SDA, as a source that offers improved cost-effective production and abundant supply as derived from transgenic plants.

According to preferred embodiments of the current invention, the preferred plant species that can be modified to supply demand are: soybeans, corn, and canola, but many other plants could also be included as needed and as scientifically practicable. Once produced the SDA of the invention can be used to improve the health characteristics of a great variety of food products. This production can also be scaled-up as needed to both reduce the need to harvest wild fish stocks and to provide essential fatty acid (FA) components for aquaculture operations, each greatly easing pressure on global fisheries and wild fish stocks.

Omega-3 fatty acids have been investigated as a potential way to improve performance and meat quality in pigs and poultry. Previous attempts to increase the concentration of beneficial fatty acids in pigs have included supplementing the diet of the pigs with ALA, EPA, or DHA. These methods include addition of highly unstable EPA or DHA which are less stable and more difficult to obtain; or incorporation of traditional omega-3 fatty acids such as alpha-linolenic acid (ALA), which are not converted to the beneficial forms efficiently enough to be practical. Nutritional studies have shown that, compared to ALA, SDA is 3 to 4 times more efficiently converted in vivo to EPA in humans (Ursin, 2003).

Surprisingly, the inventors have found that feeding pigs SDA compositions from transgenic plant sources is highly effective in increasing the omega-3 fatty acid levels of SDA (18:4), ETA (omega-3 20:4), EPA (eicosapentaenoic acid), DPA (docosapentaenoic acid) and DHA (docosahexaenoic acid) in animal tissues while concurrently decreasing the levels of the omega-6 fatty acids ARA (arachidonic acid), and docosatetraenoic acid (DTA, omega-6 22:4), thereby improving the omega-6 to omega-3 fatty acid ratio in livestock and those products made from their meat.

In particular, the incorporation of SDA into pork meat was unexpected. Previous research has shown little to no incorporation of SDA in animals. See for example James et al (2003), Harris et al (2007), and Miles et al (2004).

An improved ratio of omega-3 fatty acids in pigs is also accessible by feeding fish oil comprising DHA to them. However, the literature describes that such pork meat is associated with commercially undesirable side affects such as stability and taste and smell properties. Providing an unexpected advantage, adverse taste, smell, and stability were not found in the methods and products of the present invention. SDA feed comprising whole foods, unlike the omega 3 fatty acids commonly described in the literature, is uniquely suited for improved feed compositions which yield healthy and stable pork products for human consumption.

A further advantage of feeding SDA over alpha linolenic acid (ALA) is that SDA circumvents the biosynthetically limiting reaction of the delta-6 desaturase and is therefore much more efficiently converted to the long chain PUFA's EPA, DPA, and DHA.

### SUMMARY OF THE INVENTION

The present invention encompasses incorporation of oil from transgenic plants engineered to contain significant quantities of stearidonic acid (18:4ω3) for use in swine feed to improve the fatty acid profile of pork products derived therefrom and/or the health of a human consumer. Sufficient quantities of SDA enriched soybeans have been grown to allow the delivery of soybeans and soy oil with a substantial SDA component. According to embodiments of the current invention, the SDA soybeans of the invention provide enhanced nutritional quality relative to traditional omega-3 alternatives such as flaxseed and lack negative taste and low stability characteristics associated with fish oil. Therefore, a preferred embodiment of this invention comprises a pork product with an increased level of beneficial polyunsaturated fatty acids such as SDA, EPA, and DPA. Surprisingly, significant amounts of SDA were incorporated into the pork meat through feed supplemented with SDA.

Also according to embodiments of the current invention, testing of swine diets comprising stearidonic acid has also been conducted and SDA-containing feed has substantially improved the fatty acid profile of the resulting pork products. Therefore, a preferred embodiment of the current invention is the usage of the SDA oil produced by transgenic plants in the production of pig feed and feed supplements.

In an additional embodiment of the invention, pork products comprising SDA and DHA and a substantially improved fatty acid profile are disclosed including pork meat. Furthermore, methods of making such products are disclosed.

In an additional embodiment of the invention, pork products comprising SDA, EPA, and DHA are disclosed. Furthermore, methods of making such products are disclosed. These methods may include providing a stearidonic acid source comprising SDA, providing additional feed components, combining said stearidonic acid source with said feed components to make a supplemented feed, feeding said supplemented feed to a plurality of pigs, harvesting at least one edible product for human consumption from said pigs, wherein said stearidonic acid source comprises a transgenic plant source, and wherein some portion of said SDA is incorporated in said edible product.

In an additional embodiment of the invention, products comprising SDA, EPA, and DHA and having reduced omega-6 content are disclosed. Furthermore, methods of making such products are disclosed.

Additional embodiments of the present invention include a method of producing a pork product for human consumption comprising: providing a stearidonic acid source comprising stearidonic acid (SDA), providing additional feed components, combining said stearidonic acid source with said feed components to make a supplemented feed, feeding said supplemented feed to a plurality of pigs, harvesting at least one edible product for human consumption from said pigs, and wherein said stearidonic acid source comprises a transgenic plant source and wherein at least a portion of said SDA is incorporated in said edible product.

Embodiments of the invention include pork products for human consumption comprising stearidonic acid (SDA) and wherein the concentration of the SDA is at least about 0.05 g per 100 g of fat in the pork product and wherein a portion of the SDA is incorporated in the tissues of the pig after the pig is provided a feed composition containing SDA.

Embodiments of the invention also include methods of producing pigs comprising: a) providing a nutritious composition comprising stearidonic acid (SDA) as a feed source for the pigs; b) feeding the nutritious composition to at least one pig; and c) producing progeny from the at least one pig; wherein the nutritious composition comprises at least about 0.01% SDA.

Embodiments of the invention also include pork meat products for human consumption comprising stearidonic acid (SDA), and eicosapentaenoic acid (EPA), wherein: the concentration of the SDA is at least about 0.01 g per 100 g fat in the pork meat product; and the concentration of the EPA is at least about 0.01 g per 100 g fat in the pork meat product.

Embodiments of the invention also include methods of producing a pork product for human consumption comprising: a) providing a stearidonic acid source comprising stearidonic acid (SDA) as a component of feed for pigs; b) providing additional feed components for the pig feed composition; c) combining the stearidonic acid source with the feed components to make a supplemented feed; d) feeding the supplemented feed to a plurality of pigs; e) harvesting at least one edible product for human consumption from the pigs; wherein the stearidonic acid source comprises a transgenic plant source; and, wherein at least a portion of the SDA is incorporated into the edible product after the feeding of the plurality of pigs the SDA.

Embodiments of the invention also include swine feed comprising: a) stearidonic acid (SDA); b) gamma linolenic acid (GLA); and c) additional feed components; wherein the swine feed comprises at least about 0.10% stearidonic acid and at least about 0.07% GLA, wherein the ratio of SDA/GLA is at least about 1.3.

In an additional embodiment of the invention, a food product for human consumption comprises a pork product comprising SDA, EPA, ETA, and DHA.

Other features and advantages of this invention will become apparent in the following detailed description of preferred embodiments of this invention, taken with reference to the accompanying figures.

### DEFINITIONS

The following definitions are provided to aid those skilled in the art to more readily understand and appreciate the full scope of the present invention. Nevertheless, as indicated in the definitions provided below, the definitions provided are not intended to be exclusive, unless so indicated. Rather, they are preferred definitions, provided to focus the skilled artisan on various illustrative embodiments of the invention.

As used herein the term “pork product” refers to food products comprising the tissue of pigs.

As used herein, the term “pork meat product” refers to food products comprising at least a portion of meat from a swine animal.

“Swine” or “pig” refers to any animal of the genus sus, such as for example Sus Scrofa, which is used as a food source for human consumption. exemplary pig breeds used as commercial livestock include Berkshire, Large White, Duroc, Hampshire, Landrace, Meishan, Pietrain, and many others.

### DETAILED DESCRIPTION OF THE INVENTION

Embodiments of the invention include pork products for human consumption comprising stearidonic acid (SDA) and wherein the concentration of the SDA is at least about 0.05 g per 10 g of the fat in the pork product and wherein a portion of the SDA is incorporated in the tissues of the pig after the pig is provided a feed composition containing SDA.

Alternative embodiments of the invention further comprise DHA wherein the DPA is at least about 0.03 g per 100 g of the fat in the pork product. Alternative embodiments of the invention may further comprise EPA wherein the EPA is at least about 0.01 g per 100 g fat in the pork product. Alternative embodiments of the invention also comprise SDA concentrations of at least about 0.1, 0.2, 0.3, 0.5, 1.0, or 5.0 g per 100 g or more of the fat in the pork product. Alternative embodiments of the invention may further comprise GLA wherein the GLA concentration is at least about 0.01, 0.05, 0.1, 0.5, 1.0, 2.0, or 5.0 g per 100 g of the fat in the pork product. Alternative embodiments of the invention may further comprise ALA wherein the ratio of SDA/ALA concentration is at least about 0.1, 0.2, 0.5, 1.0, 2.0, 5.0 or more.

Alternative embodiments of the invention may further comprise tocochromanol. Alternative embodiments may include at least about 10 ppm tocochromanol such as for example, tocopherol.

Alternative embodiments of the invention include pork product selected from the group consisting of bacon, ham, pork loin, pork ribs, pork steaks, lard, pork rinds or other pork products. Alternative embodiments of the invention include pork products comprising pork meat.

Alternative embodiments of the invention also include pork products wherein the ratio of SDA/GLA is at least about 1.0, 1.5, 2.0, 2.5, 3.0, 5.0, or more. Alternative embodiments of the invention also include pork products wherein the ratio of ratio of EPA/SDA is at least about 0.05, 0.1, 0.5, 1.0, 1.5, 2.0, 2.5 or more. Alternative embodiments of the invention also include pork products wherein ratio of DHA/SDA is at least about 0.1, 0.5, 1.0, 2.0 or more. Alternative embodiments of the invention also include pork products wherein the ratio of DHA/SDA is at least about 0.5, 1.0, 1.5, 2.0, 3.0 or more.

Embodiments of the invention also include methods of producing pigs comprising: a) providing a nutritious composition comprising stearidonic acid (SDA) as a feed source for the pigs; b) feeding the nutritious composition to at least one pig; and c) producing progeny from the at least one pig; wherein the nutritious composition comprises at least about 0.01% SDA.

Alternative embodiments of the invention include methods wherein the nutritious composition comprises seeds selected from the group consisting of soybeans, safflower, sunflower, canola, and corn.

Alternative embodiments of the invention include methods wherein the SDA concentration in the nutritious composition is at least about 0.2%, 0.4%, 0.6%, 1%, 2%, 5%, or more of the total fats in the nutritious composition. In some embodiments of the invention, the reproductive performance of the at least one pig is enhanced. For example, in some embodiments, the number of progeny produced by the pig is increased.

Alternative embodiments of the invention also include methods wherein the nutritious composition further comprises GLA, and wherein the ratio of concentrations of SDA/GLA is at least about 1.0, 1.5, 2.0, 2.5, 3.0, 5.0 or more. Alternative embodiments of the invention also include methods wherein the omega-3 to omega-6 fat ratio of the nutritious composition is greater than about 2:1.

Alternative embodiments of the invention also include methods wherein the nutritious composition further comprises 6-cis, 9-cis, 12-cis, 15-trans-octadecatetraenoic acid. Alternative embodiments of the invention also include methods wherein the nutritious composition further comprises 9-cis, 12-cis, 15-trans-alpha linolenic acid. Alternative embodiments of the invention also include methods wherein the nutritious composition further comprises 6, 9-octadecadienoic acid.

Alternative embodiments of the invention also include methods wherein the nutritious composition further comprises ingredients selected from the group consisting of salt, antibiotics, corn, wheat, oats, barley, soybean meal, cottonseed meal, flaxseed meal, canola meal, wheat middlings, wheat bran, rice bran, corn distiller dried grains, corn gluten meal, corn gluten feed, molasses, rice mill byproduct, corn oil, flax oil, soy oil, palm oil, animal fat, restaurant grease, antioxidants, tocochromanols, tocopherols, vitamins, minerals, amino acids, and coccidostats.

Embodiments of the invention also include pork meat products for human consumption comprising stearidonic acid (SDA), and eicosapentaenoic acid (EPA), wherein: the concentration of the SDA is at least about 0.01 g per 100 g fats in the pork meat product; and the concentration of the EPA is at least about 0.01 g per 100 g fats in the pork meat product.

Alternative embodiments of the invention may also comprise GLA, wherein the ratio of SDA/GLA concentrations is at least about 1.2, 2.5, 3.0 or more. Alternative embodiments of the invention may also comprise ALA wherein the ratio of SDA/ALA concentrations is at least about 0.1, 0.2, 0.3, 0.5, 1.0, 2.0 or more. Alternative embodiments of the invention may also have a ratio of EPA/SDA of at least about 0.1, 0.2, 0.5, 1.0, 2.0 or more. Alternative embodiments of the invention may also comprise DHA. Alternative embodiments of the invention may also have an SDA content is at least about 0.05, 0.1, 0.2, 0.3, 0.5, 1.0, 1.5, 2.0, 5.0 or more grams per 100 g fat.

Embodiments of this invention also include food products for human consumption comprising the pork products described herein.

Embodiments of the invention also include methods of producing a pork product for human consumption comprising: a) providing a stearidonic acid source comprising stearidonic acid (SDA) as a component of feed for pigs; b) providing additional feed components for the pig feed composition; c) combining the stearidonic acid source with the feed components to make a supplemented feed; d) feeding the supplemented feed to a plurality of pigs; e) harvesting at least one edible product for human consumption from the pigs; wherein the stearidonic acid source comprises a transgenic plant source; and, wherein at least a portion of the SDA is incorporated into the edible product after the feeding of the plurality of pigs the SDA. Embodiments of the invention include methods wherein the pork product comprises pork meat.

Alternative embodiments of the invention also include methods wherein the stearidonic acid source comprises seeds selected from the group consisting of soybeans, safflower, sunflower, canola, and corn. Alternative embodiments of the invention also include methods wherein the stearidonic acid source comprises less than about 30% of the total fats in the stearidonic acid source. Alternative embodiments of the invention also include methods wherein the omega-3 to omega-6 fat ratio of the stearidonic acid source is greater than about 2:1. Alternative embodiments of the invention also include methods wherein the pork product has incorporated EPA, DHA and/or DTA into their tissues as a result of the plurality of pigs being fed stearidonic acid.

Alternative embodiments of the invention also includes methods wherein the stearidonic acid source further comprises tocochromanol; preferable embodiments comprise at least about 10 ppm of tocochromanol; additional preferred embodiments include methods wherein the tocochromanol is tocopherol.

Alternative embodiments of the invention also include methods wherein the stearidonic acid source further comprises 6-cis, 9-cis, 12-cis, 15-trans-octadecatetraenoic acid. Alternative embodiments of the invention also includes methods the stearidonic acid source further comprises 9-cis, 12-cis, 15-trans-alpha linolenic acid. Alternative embodiments of the invention also includes methods the stearidonic acid source further comprises 6, 9-octadecadienoic acid.

Alternative embodiments of the invention also includes methods wherein the additional feed component comprises ingredients selected from the group consisting of salt, antibiotics, corn, wheat, oats, barley, soybean meal, cottonseed meal, flaxseed meal, sunflower meal, canola meal, wheat middlings, wheat bran, rice bran, corn distiller dried grains, corn gluten meal, corn gluten feed, molasses, rice mill byproduct, corn oil, flax oil, soy oil, palm oil, animal fat, restaurant grease, antioxidants, tocochromanols, tocopherols, vitamins, minerals, amino acids, and coccidostats.

Embodiments of the invention also include swine feed comprising: a) stearidonic acid (SDA); b) gamma linolenic acid (GLA); and c) additional feed components;

wherein the swine feed comprises at least about 0.10% stearidonic acid and at least about 0.07% GLA, wherein the ratio of SDA/GLA is at least about 1.3.

Alternative embodiments of the invention include swine feed further comprising a transgenic plant product selected from the group consisting of transgenic soybeans, transgenic soybean oil, transgenic soy protein, transgenic corn, and transgenic canola.

Alternative embodiments of the invention include swine feed further comprising alpha-linolenic acid (ALA). Preferred embodiments also include: feeds wherein the ALA concentration is less than about 25% of the fat in the swine feed. Additional preferred embodiments also include feeds were the ratio of SDA/ALA concentrations is at least about 0.5, 1.0, 1.5, 2.0, or more.

Alternative embodiments of the invention further comprises eicosenoic acid. Preferably alternatives include feeds wherein the eicosenoic acid concentration is less than about 2.0%, 1.5%, 1.0%, 0.7% or 0.5%. Alternative embodiments of the invention include swine feeds wherein the ratio of SDA/GLA concentrations is at least about 1.0, 1.5, 2.0, 2.5, 3.0 or more. Alternative embodiments of the invention include swine feeds wherein the stearidonic acid concentration is less than about 35%, 25%, 15%, or 5% of the total fats in the feed.

Alternative embodiments of the invention include swine feeds further comprising 6-cis, 9-cis, 12-cis, 15-trans-octadecatetraenoic acid. Alternative embodiments of the invention include swine feeds further comprising 9-cis, 12-cis, 15-trans-alpha linolenic acid. Alternative embodiments of the invention include swine feeds further comprising 6, 9-octadecadienoic acid. Alternative embodiments of the invention include swine feeds further comprising tocochromanol; preferred embodiments may include at least about 10 ppm tocochromanol. Additional preferred embodiments include swine feeds wherein the tocochromanol is tocopherol.

Alternative embodiments of the invention include swine feeds wherein the additional feed components are selected from the group consisting of salt, antibiotics, corn, wheat, oats, barley, soybean meal, cottonseed meal, flaxseed meal, sunflower meal, canola meal, wheat middlings, wheat bran, rice bran, corn distiller dried grains, brewers grains, corn gluten meal, corn gluten feed, molasses, rice mill byproduct, corn oil, flax oil, soy protein, palm oil, animal fat, pigs fat, restaurant grease, antioxidants, tocochromanols, tocopherols, vitamins, minerals, amino acids, and coccidostats.

Embodiments of the present invention relate to a system for an improved method for the plant based production of stearidonic acid and its incorporation into the diets of humans and livestock in an effort to improve human health. This production is made possible through the utilization of transgenic plants engineered to produce SDA in sufficiently high yield to so as to allow commercial incorporation into food products. For the purposes of the current invention the acid and salt forms of fatty acids, for instance, butyric acid and butyrate, arachidonic acid and arachidonate, will be considered interchangeable chemical forms.

All higher plants have the ability to synthesize the main 18 carbon PUFA's, LA and ALA, and in some cases SDA (C18:4n3, SDA), but few are able to further elongate and desaturate these to produce arachidonic acid (AA), EPA or DHA. Synthesis of EPA and/or DHA in higher plants therefore requires the introduction of several genes encoding all of the biosynthetic enzymes required to convert LA into AA, or ALA into EPA and DHA. Taking into account the importance of PUFAs in human health, the successful production of PUFAs (especially the n-3 class) in transgenic oilseeds, according to the current invention can then provide a sustainable source of these essential fatty acids for dietary use. The “conventional” aerobic pathway which operates in most PUFA-synthesizing eukaryotic organisms, starts with Δ6 desaturation of both LA and ALA to yield y-linolenic (GLA, 18:3n6) and SDA.

Turning to Table 1, it is important to provide a basis of what constitutes ‘normal’ ranges of oil composition vis-à-vis the oil compositions of the current invention. A significant source of data used to establish basic composition criteria for edible oils and fats of major importance has been the Ministry of Agriculture, Fisheries and Food (MAFF) and the Federation of Oils, Seeds and Fats Associations (FOSFA) at the Leatherhead Food Research Association facility in the United Kingdom.

To establish meaningful standards data, it is essential that sufficient samples be collected from representative geographical origins and that these oils are pure. In the MAFF/FOSFA work, over 600 authentic commercial samples of vegetable oilseeds of known origin and history, generally of ten different geographical origins, were studied for each of 11 vegetable oils. The extracted oils were analyzed to determine their overall fatty acid composition (“FAC”). The FAC at the 2-position of the triglyceride, sterol and tocopherol composition, triglyceride carbon number and iodine value, protein values in the oil, melting point and solid fat content as appropriate are determined.

Prior to 1981, FAC data were not included in published standards because data of sufficient quality was not available. In 1981, standards were adopted that included FAC ranges as mandatory compositional criteria. The MAFF/FOSFA work provided the basis for later revisions to these ranges.

Turning to Table 1, it is important to provide a basis of what constitutes ‘normal’ ranges of oil composition vis-à-vis the oil compositions of the current invention. Table 1 gives examples of fatty acid content of various oils commonly used in food products, expressed as a percentage of total oil.

TABLE 1
STANDARDS FOR FATTY ACID COMPOSITION OF OILS (% OF OIL)

| | Rapeseed | | | | Arachis | | | |
|---|---|---|---|---|---|---|---|---|
| | oil (low | | | | oil | | | |
| Fatty | erucic | Sesame | Soybean | Sunflower | (peanut | Coconut | | |
| acid | acid) | seed oil | oil | seed oil | oil) | oil | Maize oil | Palm oil |
| C6:0 | ND | ND | ND | ND | ND | ND-0.7 | ND | ND |
| C8:0 | ND | ND | ND | ND | ND | 4.6-10.0 | ND | ND |
| C10:0 | ND | ND | ND | ND | ND | 5.0-8.0 | ND | ND |
| C12:0 | ND | ND | ND-0.1 | ND-0.1 | ND-0.1 | 45.1 53.2 | ND-0.3 | ND-0.5 |
| C14:0 | ND-0.2 | ND-0.1 | ND-0.2 | ND-0.2 | ND-0.1 | 16.8-21.0 | ND-0.3 | 0.5-2.0 |
| C16:0 | 2.5-7.0 | 7.9-12.0 | 8.0-13.5 | 5.0-7.6 | 8.0-14.0 | 7.5-10.2 | 8.6-16.5 | 39.3-47.5 |
| C16:1 | ND-0.6 | ND-0.2 | ND-0.2 | ND-0.3 | ND-0.2 | ND | ND-0.5 | ND-0.6 |
| C17:0 | ND-0.3 | ND-0.2 | ND-0.1 | ND-0.2 | ND-0.1 | ND | ND-0.1 | ND-0.2 |
| C17:1 | ND-0.3 | ND-0.1 | ND-0.1 | ND-0.1 | ND-0.1 | ND | ND-0.1 | ND |
| C18:0 | 0.8-3.0 | 4.5-6.7 | 2.0-5.4 | 2.7-6.5 | 1.0-4.5 | 2.0-4.0 | ND-3.3 | 3.5-6.0 |
| C18:1 | 51.0-70.0 | 34.4-45.5 | 17-30 | 14.0-39.4 | 35.0-69 | 5.0-10.0 | 20.0-42.2 | 36.0-44.0 |
| C18:2 | 15.0-30.0 | 36.9-47.9 | 48.0-59.0 | 48.3-74.0 | 12.0-43.0 | 1.0-2.5 | 34.0-65.6 | 9.0-12.0 |
| C18:3 | 5.0-14.0 | 0.2-1.0 | 4.5-11.0 | ND-0.3 | ND-0.3 | ND-0.2 | ND-2.0 | ND-0.5 |
| C20:0 | 0.2-1.2 | 0.3-0.7 | 0.1-0.6 | 0.1-0.5 | 1.0-2.0 | ND-0.2 | 0.3-1.0 | ND-1.0 |
| C20:1 | 0.1-4.3 | ND-0.3 | ND-0.5 | ND-0.3 | 0.7-1.7 | ND-0.2 | 0.2-0.6 | ND-0.4 |
| C20:2 | ND-0.1 | ND | ND-0.1 | ND | ND | ND | ND-0.1 | ND |
| C22:0 | ND-0.6 | ND-1.1 | ND-0.7 | 0.3-1.5 | 1.5-4.5 | ND | ND-0.5 | ND-0.2 |
| C22:1 | ND-2.0 | ND | ND-0.3 | ND-0.3 | ND-0.3 | ND | ND-0.3 | ND |
| C22:2 | ND-0.1 | ND | ND | ND-0.3 | ND | ND | ND | ND |
| C24:0 | ND-0.3 | ND-0.3 | ND-0.5 | ND-0.5 | 0.5-2.5 | ND | ND-0.5 | ND |
| C24:1 | ND-0.4 | ND | ND | ND | ND-0.3 | ND | ND | ND |

Source: CODEX STANDARD FOR NAMED VEGETABLE OILS, CODEX-STAN 210 (Amended 2003, 2005).
ND is non-detectable, defined as ≦0.05%.

More recently, oils from transgenic plants have been created. Some embodiments of the present invention may incorporate products of transgenic plants such as transgenic soybean oil. Transgenic plants and methods for creating such transgenic plants can be found in the literature. See for example, WO2005/021761A1. As shown in Table 2, the composition of the transgenic soy oil is substantially different than that of the accepted standards for soy oil.

TABLE 2
A comparison of transgenic soy oil and traditional soy oil fatty acid
compositions (% of Oil)

| | High | Medium | Low |
|---|---|---|---|
| | SDA | SDA | SDA |
| | Soy Oil | Soy Oil | Soy Oil |
| C14:0 (Myristic) | 0.1 | 0.1 | 0.1 |
| C16:0 (Palmitic) | 12.5 | 12.3 | 12.1 |
| C16:1 (Palmitoleic) | 0.1 | 0.1 | 0.1 |
| C18:0 (Stearic) | 4.2 | 4.6 | 4.2 |
| C18:1 (Oleic) | 16.0 | 18.7 | 19.4 |
| C18:2 (Linoleic) | 18.5 | 23.9 | 35.3 |
| C18:3 n6 (Gamma Linolenic) | 7.2 | 6.4 | 4.9 |
| C18:3 n3 (Alpha-Linolenic) | 10.3 | 10.8 | 10.1 |
| C18:4 n3 (Stearidonic) | 28.0 | 20.5 | 11.4 |
| C20:0 (Arachidic) | 0.4 | 0.4 | 0.4 |
| C20:1 (Eicosenoic) | 0.3 | 0.2 | 0.4 |
| C22:0 (Behenic) | 0.3 | 0.3 | 0.4 |
| C24:0 (Lignoceric) | 0.1 | 0.1 | 0.1 |
| 6-cis, 9-cis, 12-cis, | <0.2% | <0.2% | <0.2% |
| 15-trans-octadecatetraenoic acid | | | |
| 9-cis, 12-cis, 15-trans-alpha linolenic acid | <0.2% | <0.2% | <0.2% |
| 6,9-octadecadienoic acid | <0.2% | <0.2% | <0.2% |
| Total trans-fatty acid | 1.5 | 1.2 | 0.9 |
| Other fatty acids | 0.6 | 0.6 | 0.3 |

Given the above and according to embodiments of the current invention, the SDA rich soybeans produced in a recombinant oilseed plant provides a composition not previously available for feed manufacturers. Various embodiments of the invention provide for the incorporation of seed or seed oil into swine feed with a unique fatty acid profile that was not present in appreciable amounts in typical feeds prior to the current invention. In addition the use of this feed is made possible without the traditional concerns with stability when oils comprising DHA are delivered from a fish or algal source. The feed incorporating such transgenic plant seeds can be further utilized for the production of food products including pork products having enhanced nutritional content.

For the instant invention the preferred source of stearidonic acid is transgenic soybeans which have been engineered to produce high levels of stearidonic acid. The soybeans may be processed at an oil processing facility and oil may be extracted consistent with the methods described in us patent applications 2006/0111578A1, 2006/0110521A1, and 2006/0111254A1.

### Methods of Feeding Swine:

Accordingly, in embodiments of the present invention, the methods comprise increasing the levels of Omega-3 fatty acids where stearidonic acid is added to said livestock feed in an amount in excess of 0.1% of the feed, in excess of 0.2% of the feed, in excess of 0.5% of the feed, and in excess of 0.8% of the feed, where the percentages are based on the total fatty acid concentration of the animal feed. In some embodiments, the concentration of SDA may be added to the livestock feed in amounts as high as 5% or even 10% of the total fatty acid concentrations. The source of added stearidonic acid can be synthetic or natural. The natural stearidonic acid is sourced from a grain or marine oils or from oils from the group consisting of palm oil, sunflower oil, safflower oil, cottonseed oil, canola oil, corn oil, soybean oil, and flax oil. The natural stearidonic acid in the grain or oilseed is genetically modified to an elevated level in such grain or oil as compared to the levels of stearidonic acid found in the native grain or oil.

The SDA may be incorporated in the diet in the form of a whole seed, ground or cracked seed, extruded seed, extracted oil, triglyceride, or ethyl ester. SDA may be incorporated into the diet and fed to the pigs in a meal, crumble, pellet, encapsulated form, whole, cracked, ground or extruded seeds. The SDA may be combined with grains (i.e., corn, wheat, barley), oilseed meals (i.e., soybean meal, cottonseed meal, flaxseed meal, canola meal, sunflower meal), byproducts (i.e., wheat middlings, wheat bran, rice bran, corn distiller dried grains, brewers grains, corn gluten meal, corn gluten feed, molasses, rice mill byproduct), oils (i.e., corn oil, flax oil, soy oil, palm oil, animal fat, restaurant grease, and blends thereof), vitamin and minerals, amino acids, antioxidants, tocochromanols, tocopherols, coccidostats and/or antibiotics, enzymes (i.e., phytase, xylanase) or any other feed additives.

Improved Pork Products:

Preferred embodiments of the present invention comprise methods of increasing the levels of omega 3 fatty acids in the meat of swine, where the method comprises adding stearidonic acid to a swine feed in a an amount at least about 0.2% of the feed, 0.5% of the feed, 0.8% of the feed, 1.5% of the feed, 5% of the feed, 10% of the feed, 20% of the feed, or more, based on the total fatty acid concentration in the feed.

There are numerous processes known in the art for processing animal flesh into meat products, any of which may be combined with methods for feeding pigs SDA as described herein. These processes include cutting into large cuts of whole meat, such as for hams, steaks, and chops; mechanically shearing and mixing the meat such as for sausages, hamburger, and hot dogs; reforming smaller pieces into processed meats such as for bologna, salami, and the like; injecting water, bouillon, flavorings, or brine to enhance flavor and organoleptic properties; etc.

Examples of meat processing methods include the following US Patents No.#'s: and applications, each of which is herein incorporated by reference: U.S. Pat. No. 3,556,809, U.S. Pat. No. 3,916,777, U.S. Pat. No. 4,463,027, U.S. Pat. No. 4,584,204, U.S. Pat. No. 4,778,682, U.S. Pat. No. 4,867,986, U.S. Pat. No. 4,904,496, U.S. Pat. No. 4,980,185, U.S. Pat. No. 5,053,237, U.S. Pat. No. 5,082,678, U.S. Pat. No. 5,106,639, U.S. Pat. No. 5,116,629, U.S. Pat. No. 5,116,633, U.S. Pat. No. 5,211,976, U.S. Pat. No. 5,213,829, U.S. Pat. No. 5,250,006, U.S. Pat. No. 5,256,433, U.S. Pat. No. 5,380,545, U.S. Pat. No. 5,382,444, U.S. Pat. No. 5,415,883, U.S. Pat. No. 5,460,842, U.S. Pat. No. 5,468,510, U.S. Pat. No. 5,472,725, U.S. Pat. No. 5,474,790, U.S. Pat. No. 5,484,625, U.S. Pat. No. 5,489,443, U.S. Pat. No. 5,492,711, U.S. Pat. No. 5,514,396, U.S. Pat. No. 5,523,102, U.S. Pat. No. 5,556,662, U.S. Pat. No. 5,631,035, U.S. Pat. No. 5,674,550, U.S. Pat. No. 5,688,549, U.S. Pat. No. 5,698,255, U.S. Pat. No. 5,807,598, U.S. Pat. No. 5,895,674, U.S. Pat. No. 5,965,191, U.S. Pat. No. 5,989,601, US6014926, U.S. Pat. No. 6,054,147, U.S. Pat. No. 6,099,891, U.S. Pat. No. 6,103,276, U.S. Pat. No. 6,248,381, U.S. Pat. No. 6,613,364, U.S. Pat. No. 6,613,369, U.S. Pat. No. 6,716,460, U.S. Pat. No. 6,749,884, U.S. Pat. No. 6,763,760, U.S. Pat. No. 6,976,421, U.S. Pat. No. 7,022,360, U.S. Pat. No. 7,026,007, U.S. Pat. No. 7,169,421, US2003049364A1, US2003198730A1, US2004001876A1, US2004047948A1, US2004166212A1, US2005142278A1, US20060068077A1, US20060088651A1, US2006068077A1, US2006286273A1, US2007004678A1, WO02065860A1, WO04082403A1, WO05034652A1, and WO05094617A1.

### Improved Animal Productivity

In food production, and specifically producing livestock animal products such as milk, beef, poultry, pork, fish etc., there is need to improve production efficiency. Production efficiency, that is the production of the maximum quantity of animal products while minimizing the time and cost of production for those products, is important in maintaining a competitive economic advantage. In such an industry, a producer (i.e. a farmer or rancher) generally wants to maximize the amount of animal product produced (e.g. gallons of milk, pounds of pork or progeny produced) while keeping the costs associated with feed as low as possible in order to achieve maximum animal productivity. The maximized amount of animal product should be produced at a minimized cost to the producer. Costs to the producer include the cost of feed needed to produce the animal products, as well as the costs of related equipment and housing facilities for the animals. Importantly, to maximize productivity gains relative to costs such gains should preferably be produced in a minimum time period.

Producers are constantly trying to increase these production efficiencies. One way of increasing production efficiencies is by altering the feed which animals are fed. For example, a feed with certain amounts of nutrients can cause an animal to grow or produce animal products quickly and/or perform better in the production of desirable products, whereas a different feed with different amounts of nutrients may cause an animal to grow or produce animal products on a more cost effective basis. (Calder (2002); Klasing (2000); and, Mattos (2000)).

One embodiment of the present invention provides a method for improving animal productivity by providing lower cost plant-based omega-3 fatty acids such that it can become a regular part of the diet and will in turn enhance animal reproductive capacity, and overall productivity. (Calder (2002); Klasing (2000); and, Mattos (2000)).

Another embodiment of the invention provides methods for improving animal productivity by providing SDA in the animal feed whereby reproductive performance of the animals is improved such as more live pigs per litter and less embryonic mortality.

### Illustrative Embodiments of the Invention

The following examples are included to demonstrate general embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the invention.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied without departing from the concept and scope of the invention.

In the examples below, SDA ethyl esters were used in place of traditional oils to isolate the specific fatty acid and allow for higher dosages. Similar results can be obtained when feeding oil derived from transgenic plants such as soy, corn, or canola. Application of ethyl esters of fatty acids is a common practice in the nutritional sciences. See, for example, Krokhan et al, 1993; Arachchige et al, 2006; Martinez et al, 2000; Lim et al, 2000; and Allen et al, 1998.

### Example 1

### Pork Meat Products with Beneficial Fatty Acids—A 35 Day Study

A 35 day study was conducted to determine whether pigs fed a diet containing SDA could produce meat with improved fatty acid profiles including increased levels of SDA, EPA, and DHA.

The dietary treatments are shown in Table 3.

TABLE 3
Dietary Treatments for Pigs Fed n-3 Enriched
Diets from Day (21-42).

| Treatment | Description |
|---|---|
| 1 | Control (Corn Oil) |
| 2 | 0.2% SDA -Ethyl Esters |
| 3 | 0.4% SDA - Ethyl Esters |
| 4 | 0.6% SDA - Ethyl Esters |
| 5 | 0.8% SDA Ethyl Esters |

The percentage levels refer to approximate compositions of SDA in the feed on a gram per gram basis.

A control diet (Treatment 1) formulated to meet or exceed NRC (1998) nutrient requirements for pigs in the late finishing phase (approximately 80-120 kg BW containing 1.14% corn oil and no added SDA ethyl ester (70% w/w SDA) were fed ad libitum during an acclimation period of at least 1 week duration. Ethoxyquin was included in all diets as an antioxidant at a concentration of 150 parts per million (0.015%, as-fed basis), the maximum level allowed by FDA regulation in animal feeds. The same control diet was fed ad libitum to the control pigs (pen receiving Treatment 1) throughout a 35-day test period. Four test diets (Treatment 2, 3, 4, and 5) with SDA ethyl ester substituted for corn oil to provide 0.2, 0.4, 0.6 and 0.8% (w/w SDA active ingredient, as-is basis) were fed ad libitum to one pen of four pigs throughout the 35-day test period Table 4). The ingredient composition of Treatments 1 and 5 are presented in Table 1. All diets were fed in meal form.

Immediately after diet preparation, samples (approximately 300 g) of each of the five test diets were collected, frozen and stored at approximately 20° C. Samples were tested for dry matter, crude protein and crude fat. On the first and last day of the test period, a sample (˜300 g) of each diet was collected and stored frozen at approximately 20° C. Upon completion of the animal feeding phase of the study, feed samples (mixing, and start and finish of feeding) were analyzed for fatty acids.

All pigs were individually weighed at initiation of the acclimation and test period, and immediately prior to slaughter. Feed consumption per pen was recorded. Upon completion of the feeding period, pigs were slaughtered for tissue collection and carcass evaluation. Pigs were slaughtered using standard industry practices (electrical stunning, exsanguinations, scalding, dehairing and evisceration). Live weights prior to slaughter and hot carcass weights were recorded. The left side of each carcass was fabricated and samples were obtained from the loin (longissimus muscle), ham (semi-membraneous muscle) and belly (a section from the center of the belly) for sensory evaluation, fatty acid, and proximate analysis. Prior to removing the sample for sensory and fatty and proximate analysis from the belly the firmness of the belly was evaluated using a flop test. At 24 hr postmortem fat thickness (10th rib), loin eye area (10th rib), visual color, firmness and marbling, Minolta color (L*a*b*), pH, and drip loss were measured.

Sensory Evaluation: Samples (ham and loin) for sensory analysis were thawed 24 hr. at 4° C. and cooked to an internal temperature of 70° C. Belly samples were cooked to a medium degree of doneness in an oven. Samples were served to a 6 member trained panel that evaluated tenderness, juiciness and off flavor using a 15 cm unstructured line scale where 0=extremely tough, dry or no off flavor and 15=extremely tender, juicy or intense off flavor.

TABLE 4
Ingredient and calculated composition of diets (as-fed basis)

| | Diet 1 | Diet 5 |
|---|---|---|
| Ingredient, % | | |
| Corn, Yellow #2 | 88.433 | 88.433 |
| Soybean meal (dehulled) | 7.849 | 7.849 |
| Corn oil | 1.140 | 0 |
| SDA ethyl ester (70% w/w SDA) | 0 | 1.140 |
| Dicalcium phosphate (21:18) | 0.774 | 0.774 |
| Limestone | 0.717 | 0.717 |
| Trace mineral salt^{a} | 0.350 | 0.350 |
| Vitamin mix^{b} | 0.100 | 0.100 |
| L-Lysine | 0.217 | 0.217 |
| DL-Methionine | 0.257 | 0.257 |
| L-Threonine | 0.075 | 0.075 |
| L-Tryptophan | 0.023 | 0.023 |
| Tylan | 0.050 | 0.050 |
| Ethoxyquin | 0.015 | 0.015 |
| Total | 100 | 100 |
| Calculated nutrients | | |
| ME, kcal/kg | 3395 | 3395 |
| Crude protein, % | 11.72 | 11.72 |
| Crude fat, % | 4.70 | 4.70 |
| Crude fiber, % | 1.93 | 1.93 |
| Ca, % | 0.47 | 0.47 |
| Available P, % | 0.19 | 0.19 |
| Total lysine, % | 0.69 | 0.69 |
| Digestible lysine, % | 0.61 | 0.61 |
| Total Met + Cys, % | 0.69 | 0.69 |
| Digestible Met + Cys, % | 0.64 | 0.64 |
| Digestible threonine, % | 0.41 | 0.41 |
| Digestible tryptophan, % | 0.12 | 0.12 |
| Digestible valine, % | 0.46 | 0.46 |

^{a}Supplemented the following per kilogram of complete diet: Se, 0.30 mg; I, 0.35 mg; Cu, 8 mg; Mn, 20 mg; Fe, 90 mg; Zn, 100 mg; NaCl, 2.8 g.
^{b}Supplemented the following per kilogram of complete diet: vitamin A, 3,307 IU; vitamin D₃, 331 IU; vitamin E, 44 mg; vitamin K, 2.2 mg; vitamin B₁₂, 17.9 μg; riboflavin, 4.4 mg; d-pantothenic acid, 12.1 mg, niacin, 16.5 mg; choline chloride, 143 mg.
^{c}Approximation based on assigning the same ME value to SDA ethyl ester as that of corn oil.

Diet 2 was a blend of 75% Diet 1 and 25% Diet 5. Diet 3 was a blend of 50% Diet 1 and 50% Diet 5. Diet 4 was a blend of 25% Diet 1 and 75% Diet 5.
The fatty acid compositions of the diets are presented in Table 5.

TABLE 5
Composition of Test Diets (mg FA per 100 g Feed) (Days 0-35)

| | Control | 0.2% | 0.4% | 0.6% | 0.8% |
|---|---|---|---|---|---|
| | (Corn Oil) | SDA | SDA | SDA | SDA |
| | Diet 1 | Diet 2 | Diet 3 | Diet 4 | Diet 5 |
| 12:0 | 9.1 | 10.0 | 9.9 | 9.0 | 7.9 |
| 14:0 | 20.3 | 22.3 | 19.8 | 18.6 | 16.5 |
| 16:0 | 601.0 | 592.6 | 541.5 | 477.1 | 429.9 |
| 16:1 n-9 | 0.9 | 1.6 | 0.3 | 0.1 | 0.9 |
| 16:1 n-7 | 5.0 | 5.5 | 4.1 | 3.5 | 3.9 |
| 18:0 | 83.5 | 82.5 | 75.0 | 63.8 | 59.6 |
| 18:1 n-9 | 1035.2 | 1003.3 | 876.3 | 742.0 | 671.7 |
| 18:1 n-7 | 27.1 | 26.8 | 25.2 | 22.2 | 20.1 |
| 18:2 n-6 (LA) | 2393.7 | 2288.8 | 2056.1 | 1767.1 | 1549.5 |
| 18:3 n-6 (GLA) | 1.5 | 21.3 | 41.2 | 58.2 | 66.7 |
| 18:3 n-3 (ALA) | 79.1 | 86.9 | 91.3 | 90.3 | 85.1 |
| 18:4 n-3 (SDA) | 8.1 | 262.1 | 535.7 | 769.3 | 885.6 |
| 20:0 | 16.7 | 23.3 | 31.2 | 36.5 | 39.7 |
| 20:1 n-11 | 0.8 | 1.3 | 2.4 | 0.1 | 0.0 |
| 20:1 n-9 | 10.6 | 9.0 | 6.6 | 0.7 | 0.0 |
| 20:1 n-7 | 0.0 | 0.0 | 0.1 | 0.1 | 0.1 |
| 20:2 n-6 | 0.0 | 0.0 | 0.0 | 0.0 | 0.0 |
| 20:3 n-3 | 0.0 | 0.0 | 0.0 | 0.0 | 0.0 |
| 20:3 n-6 (DGLA) | 0.0 | 0.0 | 0.0 | 0.1 | 0.2 |
| 20:4 n-3 (ETA) | 0.0 | 0.1 | 0.0 | 0.0 | 0.0 |
| 20:4 n-6 (AA) | 0.0 | 0.0 | 2.0 | 3.9 | 5.2 |
| 20:5 n-3 (EPA) | 0.0 | 9.2 | 19.8 | 28.1 | 32.3 |
| 22:0 | 6.7 | 6.2 | 7.0 | 4.9 | 5.2 |
| 22:1 n-11 | 0.0 | 0.0 | 0.0 | 0.0 | 0.0 |
| 22:1 n-9 | 0.0 | 0.0 | 0.0 | 0.0 | 0.0 |
| 22:1 n-13 | 0.0 | 0.0 | 0.0 | 0.6 | 0.4 |
| 22:2 n-7 | 0.0 | 0.0 | 0.0 | 0.0 | 0.0 |
| Std Dev (22:2 n-7) | 0.0 | 0.0 | 0.0 | 0.0 | 0.0 |
| 22:3 n-6 | 0.0 | 0.0 | 0.0 | 1.0 | 0.0 |
| 22:5 n-3 (DPA) | 0.0 | 0.0 | 0.0 | 0.0 | 0.1 |
| 22:6 n-3 (DHA) | 0.0 | 0.0 | 0.0 | 0.0 | 0.0 |
| 24:1 n-9 | 0.0 | 1.9 | 0.0 | 1.6 | 0.0 |
| Total saturates | 737.4 | 737.0 | 684.5 | 610.0 | 558.8 |
| Total monoenes | 1079.5 | 1049.4 | 915.0 | 771.0 | 697.1 |
| Total n-6 | 2395.3 | 2310.2 | 2099.3 | 1830.3 | 1621.6 |
| Total n-3 | 87.2 | 358.3 | 646.9 | 887.7 | 1003.1 |
| Total PUFA | 2482.5 | 2668.5 | 2746.2 | 2718.0 | 2624.7 |
| n-6/n-3 | 27.5 | 6.4 | 3.2 | 2.1 | 1.6 |

In order to evaluate the fatty acid composition of pig tissues (loin, ham, skin, and belly), samples were stored at −80° C. until evaluation. After thawing, ˜22 g of fresh pig tissue was chopped into small pieces and thoroughly mixed before 10 g was sub sampled and lyophilized. Lyophilized samples were ground in 30 ml Sarstedt tubes with two ball bearings using a Mega Grinder. Ground samples (loin and ham: 50 mg; skin: 100 mg; belly: 150 mg; diet: 500 mg) were directly methylated with sulfuric acid in methanol (loin and ham: 1 mL; skin: 3 mL; belly: 10 mL; diet: 1.5 mL) sealed in the presence of butylated hydroxytoluene (50 mg BHT in 100 ml reagent) in reflux conditions of 90° C. Resultant fatty acid methyl esters (FAME's) were separated by capillary gas chromatography (GC) and detected by flame ionization detector (FID). The column used was a Supelco Omegawax 250 capillary column with dimensions of 30 m×0.25 mm×0.25 μm film thickness. The run time was 32 minutes. Peaks were identified based on their relative retention time compared to a FAME reference mixture. Quantification was achieved by using an internal standard (c15:0 triacylglyceride (TAG) for pig tissue samples and c17:0 TAG for diet samples). Results are reported as FA g/100 g fat with theoretical response correction.

For Table 6 below, each value represents g/100 g fat a mean of 4 samples (1 sample from each of 4 pigs) per treatment.

TABLE 6
Fatty Acid Composition Pork Products -
Belly (g FA per 100 g fat)¹

| | Belly | | | | |
|---|---|---|---|---|---|
| Sample Type | 0.2% | 0.4% | 0.6% | 0.8% | |
| Feed | SDA | SDA | SDA | SDA | Control |
| 12:0 | 0.07 | 0.07 | 0.08 | 0.08 | 0.07 |
| 14:0 | 1.28 | 1.23 | 1.32 | 1.34 | 1.21 |
| 16:0 | 23.25 | 23.20 | 23.76 | 23.71 | 22.76 |
| 16:1 n-9 | 0.29 | 0.26 | 0.30 | 0.27 | 0.28 |
| 16:1 n-7 | 2.86 | 2.63 | 2.51 | 2.98 | 3.05 |
| 18:0 | 10.97 | 11.45 | 12.24 | 11.43 | 10.20 |
| 18:1 n-9 | 40.31 | 40.91 | 40.78 | 40.73 | 41.82 |
| 18:1 n-7 | 3.14 | 2.89 | 2.62 | 2.73 | 3.36 |
| 18:2 n-6 (LA) | 10.63 | 9.79 | 8.74 | 8.56 | 10.49 |
| 18:3 n-6 (GLA) | 0.04 | 0.06 | 0.07 | 0.09 | 0.03 |
| 18:3 n-3 (ALA) | 0.46 | 0.44 | 0.42 | 0.44 | 0.44 |
| 18:4 n-3 (SDA) | 0.10 | 0.27 | 0.34 | 0.65 | 0.00 |
| 20:0 | 0.22 | 0.19 | 0.20 | 0.18 | 0.19 |
| 20:1 n-11 | 0.00 | 0.00 | 0.01 | 0.01 | 0.00 |
| 20:1 n-9 | 0.69 | 0.63 | 0.65 | 0.54 | 0.71 |
| 20:1 n-7 | 0.04 | 0.03 | 0.03 | 0.03 | 0.03 |
| 20:2 n-6 | 0.43 | 0.39 | 0.37 | 0.31 | 0.44 |
| 20:3 n-3 | 0.06 | 0.06 | 0.01 | 0.00 | 0.06 |
| 20:3 n-6 (DGLA) | 0.08 | 0.09 | 0.10 | 0.10 | 0.08 |
| 20:4 n-3 (ETA) | 0.26 | 0.55 | 0.60 | 0.93 | 0.00 |
| 20:4 n-6 (AA) | 0.21 | 0.19 | 0.20 | 0.18 | 0.23 |
| 20:5 n-3 (EPA) | 0.00 | 0.00 | 0.07 | 0.11 | 0.00 |
| 22:0 | 0.00 | 0.00 | 0.00 | 0.00 | 0.00 |
| 22:1 n-11 | 0.00 | 0.00 | 0.00 | 0.00 | 0.00 |
| 22:1 n-9 | 0.00 | 0.00 | 0.00 | 0.00 | 0.00 |
| 22:1 n-13 | 0.00 | 0.00 | 0.00 | 0.00 | 0.00 |
| 22:2 n-7 | 0.00 | 0.00 | 0.00 | 0.00 | 0.00 |
| 22:3 n-6 | 0.07 | 0.06 | 0.04 | 0.03 | 0.08 |
| 22:5 n-3 (DPA) | 0.13 | 0.19 | 0.13 | 0.14 | 0.04 |
| 22:6 n-3 (DHA) | 0.00 | 0.00 | 0.00 | 0.00 | 0.00 |
| 24:1 n-9 | 0.00 | 0.00 | 0.00 | 0.00 | 0.00 |
| Total saturates | 35.80 | 36.15 | 37.60 | 36.74 | 34.44 |
| Total monoenes | 47.32 | 47.35 | 46.90 | 47.29 | 49.25 |
| Total n-6 | 11.46 | 10.58 | 9.51 | 9.28 | 11.35 |
| Std Dev (Total n-6) | 0.06 | 0.07 | 0.04 | 0.06 | 0.21 |
| Total n-3 | 1.01 | 1.51 | 1.58 | 2.27 | 0.54 |
| Total PUFA | 12.46 | 12.09 | 11.08 | 11.55 | 11.89 |
| n-6/n-3 | 11.35 | 7.01 | 6.02 | 4.09 | 21.02 |

¹Total fat (g) per 100 g fresh tissue was 52.8, 57.6, 45.0, 52.4 and 57.4
for the 0.2% SDA, 0.4% SDA, 0.6% SDA, 0.8% SDA and Control,
respectively.

Fatty Acid Composition Pork Products -
Loin (g FA per 100 g fat)¹

| | Loin (Longissimus) | | | | |
|---|---|---|---|---|---|
| Sample Type | 0.2% | 0.4% | 0.6% | 0.8% | |
| Feed | SDA | SDA | SDA | SDA | Control |
| 12:0 | 0.07 | 0.07 | 0.08 | 0.07 | 0.08 |
| 14:0 | 1.21 | 1.15 | 1.21 | 1.13 | 1.21 |
| 16:0 | 23.54 | 23.25 | 23.68 | 22.89 | 23.36 |
| 16:1 n-9 | 0.22 | 0.20 | 0.24 | 0.20 | 0.23 |
| 16:1 n-7 | 3.44 | 3.25 | 3.10 | 3.37 | 3.41 |
| 18:0 | 11.65 | 12.23 | 12.64 | 12.36 | 11.43 |
| 18:1 n-9 | 39.43 | 40.70 | 39.49 | 40.24 | 41.12 |
| 18:1 n-7 | 4.04 | 3.86 | 3.67 | 4.05 | 3.94 |
| 18:2 n-6 (LA) | 8.13 | 7.21 | 7.44 | 6.95 | 7.91 |
| 18:3 n-6 (GLA) | 0.07 | 0.06 | 0.08 | 0.09 | 0.04 |
| 18:3 n-3 (ALA) | 0.19 | 0.19 | 0.20 | 0.16 | 0.22 |
| 18:4 n-3 (SDA) | 0.00 | 0.05 | 0.12 | 0.12 | 0.00 |
| 20:0 | 0.21 | 0.18 | 0.17 | 0.18 | 0.19 |
| 20:1 n-11 | 0.00 | 0.05 | 0.01 | 0.02 | 0.00 |
| 20:1 n-9 | 0.59 | 0.52 | 0.54 | 0.56 | 0.60 |
| 20:1 n-7 | 0.01 | 0.00 | 0.01 | 0.00 | 0.00 |
| 20:2 n-6 | 0.24 | 0.26 | 0.17 | 0.07 | 0.28 |
| 20:3 n-3 | 0.00 | 0.01 | 0.01 | 0.00 | 0.01 |
| 20:3 n-6 (DGLA) | 0.25 | 0.23 | 0.26 | 0.28 | 0.16 |
| 20:4 n-3 (ETA) | 0.05 | 0.17 | 0.25 | 0.24 | 0.00 |
| 20:4 n-6 (AA) | 1.61 | 1.22 | 1.36 | 1.53 | 1.06 |
| 20:5 n-3 (EPA) | 0.10 | 0.18 | 0.27 | 0.39 | 0.00 |
| 22:0 | 0.00 | 0.00 | 0.00 | 0.01 | 0.00 |
| 22:1 n-11 | 0.00 | 0.00 | 0.00 | 0.00 | 0.00 |
| 22:1 n-9 | 0.00 | 0.00 | 0.00 | 0.00 | 0.00 |
| 22:1 n-13 | 0.00 | 0.00 | 0.00 | 0.00 | 0.00 |
| 22:2 n-7 | 0.00 | 0.00 | 0.00 | 0.00 | 0.00 |
| 22:3 n-6 | 0.19 | 0.17 | 0.16 | 0.17 | 0.20 |
| 22:5 n-3 (DPA) | 0.32 | 0.35 | 0.38 | 0.48 | 0.13 |
| 22:6 n-3 (DHA) | 0.04 | 0.00 | 0.08 | 0.01 | 0.00 |
| 24:1 n-9 | 0.00 | 0.00 | 0.00 | 0.01 | 0.00 |
| Total saturates | 36.67 | 36.89 | 37.77 | 36.63 | 36.26 |
| Total monoenes | 47.72 | 48.60 | 47.05 | 48.46 | 49.30 |
| Total n-6 | 10.49 | 9.16 | 9.46 | 9.10 | 9.65 |
| Std Dev (Total n-6) | 0.06 | 0.01 | 0.04 | 0.09 | 0.03 |
| Total n-3 | 0.71 | 0.94 | 1.30 | 1.40 | 0.36 |
| Total PUFA | 11.19 | 10.10 | 10.76 | 10.50 | 10.02 |
| n-6/n-3 | 14.77 | 9.74 | 7.28 | 6.50 | 26.81 |

¹Total fat (g) per 100 g fresh tissue was 4.7, 4.5, 3.4, 2.5, and 5.5 for the
0.2% SDA, 0.4% SDA, 0.6% SDA, 0.8% SDA and Control, respectively.

Fatty Acid Composition Pork Products -
Ham (g FA per 100 g fat)¹

| | Ham (Semi-membranous) | | | | |
|---|---|---|---|---|---|
| Sample Type | 0.2% | 0.4% | 0.6% | 0.8% | |
| Feed | SDA | SDA | SDA | SDA | Control |
| 12:0 | 0.06 | 0.06 | 0.06 | 0.05 | 0.05 |
| 14:0 | 1.06 | 1.10 | 1.05 | 0.96 | 0.92 |
| 16:0 | 21.24 | 21.45 | 21.49 | 20.70 | 20.17 |
| 16:1 n-9 | 0.26 | 0.25 | 0.26 | 0.53 | 0.26 |
| 16:1 n-7 | 3.58 | 3.45 | 3.03 | 2.90 | 3.31 |
| 18:0 | 10.13 | 10.74 | 11.47 | 11.25 | 10.72 |
| 18:1 n-9 | 40.91 | 39.94 | 37.64 | 35.19 | 35.25 |
| 18:1 n-7 | 4.55 | 4.28 | 4.08 | 4.27 | 4.49 |
| 18:2 n-6 (LA) | 8.86 | 9.18 | 9.92 | 11.90 | 13.41 |
| 18:3 n-6 (GLA) | 0.08 | 0.09 | 0.14 | 0.21 | 0.13 |
| 18:3 n-3 (ALA) | 0.20 | 0.26 | 0.22 | 0.25 | 0.21 |
| 18:4 n-3 (SDA) | 0.03 | 0.03 | 0.16 | 0.24 | 0.00 |
| 20:0 | 0.16 | 0.16 | 0.16 | 0.13 | 0.14 |
| 20:1 n-11 | 0.04 | 0.04 | 0.03 | 0.03 | 0.04 |
| 20:1 n-9 | 0.69 | 0.66 | 0.59 | 0.52 | 0.61 |
| 20:1 n-7 | 0.04 | 0.04 | 0.04 | 0.04 | 0.03 |
| 20:2 n-6 | 0.38 | 0.36 | 0.28 | 0.27 | 0.46 |
| 20:3 n-3 | 0.03 | 0.04 | 0.04 | 0.03 | 0.03 |
| 20:3 n-6 (DGLA) | 0.29 | 0.32 | 0.43 | 0.50 | 0.46 |
| 20:4 n-3 (ETA) | 0.09 | 0.14 | 0.26 | 0.29 | 0.01 |
| 20:4 n-6 (AA) | 1.96 | 1.90 | 2.60 | 3.12 | 3.85 |
| 20:5 n-3 (EPA) | 0.17 | 0.23 | 0.54 | 0.87 | 0.07 |
| 22:0 | 0.03 | 0.04 | 0.07 | 0.10 | 0.05 |
| 22:1 n-11 | 0.00 | 0.00 | 0.00 | 0.00 | 0.00 |
| 22:1 n-9 | 0.00 | 0.01 | 0.00 | 0.00 | 0.00 |
| 22:1 n-13 | 0.00 | 0.00 | 0.00 | 0.00 | 0.00 |
| 22:2 n-7 | 0.00 | 0.00 | 0.00 | 0.00 | 0.00 |
| 22:3 n-6 | 0.24 | 0.26 | 0.24 | 0.24 | 0.54 |
| 22:5 n-3 (DPA) | 0.39 | 0.44 | 0.67 | 0.83 | 0.31 |
| 22:6 n-3 (DHA) | 0.09 | 0.08 | 0.10 | 0.13 | 0.05 |
| 24:1 n-9 | 0.04 | 0.05 | 0.06 | 0.07 | 0.07 |
| Total saturates | 32.68 | 33.55 | 34.30 | 33.18 | 32.05 |
| Total monoenes | 50.11 | 48.71 | 45.72 | 43.54 | 44.06 |
| Total n-6 | 11.81 | 12.11 | 13.60 | 16.25 | 18.83 |
| Std Dev (Total n-6) | 0.08 | 0.03 | 0.13 | 0.06 | 0.05 |
| Total n-3 | 1.01 | 1.23 | 1.99 | 2.64 | 0.68 |
| Total PUFA | 12.82 | 13.34 | 15.59 | 18.89 | 19.51 |
| n-6/n-3 | 11.69 | 9.85 | 6.83 | 6.16 | 27.69 |

¹Total fat (g) per 100 g fresh tissue was 3.2, 3.3, 2.2, 1.9, and 2.0 for the
0.2% SDA, 0.4% SDA, 0.6% SDA, 0.8% SDA and Control, respectively.

Fatty Acid Composition Pork Products -
Skin (g FA per 100 g fat)¹

| | Skin | | | | |
|---|---|---|---|---|---|
| Sample Type | 0.2% | 0.4% | 0.6% | 0.8% | |
| Feed | SDA | SDA | SDA | SDA | Control |
| 12:0 | 0.07 | 0.06 | 0.07 | 0.07 | 0.05 |
| 14:0 | 1.29 | 1.28 | 1.29 | 1.31 | 1.33 |
| 16:0 | 21.57 | 21.05 | 21.32 | 21.72 | 21.23 |
| 16:1 n-9 | 0.30 | 0.25 | 0.34 | 0.27 | 0.27 |
| 16:1 n-7 | 3.92 | 4.16 | 3.34 | 4.31 | 4.57 |
| 18:0 | 7.91 | 7.42 | 8.54 | 7.85 | 7.08 |
| 18:1 n-9 | 42.37 | 44.52 | 42.68 | 43.68 | 43.37 |
| 18:1 n-7 | 4.31 | 4.59 | 3.80 | 4.38 | 4.97 |
| 18:2 n-6 (LA) | 10.92 | 9.23 | 10.60 | 8.56 | 10.02 |
| 18:3 n-6 (GLA) | 0.03 | 0.03 | 0.06 | 0.07 | 0.01 |
| 18:3 n-3 (ALA) | 0.50 | 0.43 | 0.52 | 0.43 | 0.45 |
| 18:4 n-3 (SDA) | 0.05 | 0.12 | 0.28 | 0.34 | 0.00 |
| 20:0 | 0.18 | 0.11 | 0.16 | 0.14 | 0.16 |
| 20:1 n-11 | 0.02 | 0.02 | 0.02 | 0.03 | 0.03 |
| 20:1 n-9 | 0.73 | 0.76 | 0.73 | 0.64 | 0.81 |
| 20:1 n-7 | 0.05 | 0.07 | 0.05 | 0.05 | 0.06 |
| 20:2 n-6 | 0.52 | 0.40 | 0.50 | 0.40 | 0.48 |
| 20:3 n-3 | 0.07 | 0.06 | 0.09 | 0.07 | 0.08 |
| 20:3 n-6 (DGLA) | 0.10 | 0.10 | 0.12 | 0.11 | 0.09 |
| 20:4 n-3 (ETA) | 0.19 | 0.37 | 0.53 | 0.59 | 0.04 |
| 20:4 n-6 (AA) | 0.30 | 0.27 | 0.26 | 0.27 | 0.33 |
| 20:5 n-3 (EPA) | 0.02 | 0.02 | 0.07 | 0.09 | 0.00 |
| 22:0 | 0.00 | 0.00 | 0.00 | 0.00 | 0.00 |
| 22:1 n-11 | 0.00 | 0.00 | 0.00 | 0.00 | 0.00 |
| 22:1 n-9 | 0.00 | 0.00 | 0.00 | 0.00 | 0.00 |
| 22:1 n-13 | 0.00 | 0.00 | 0.00 | 0.00 | 0.00 |
| 22:2 n-7 | 0.00 | 0.00 | 0.00 | 0.00 | 0.00 |
| 22:3 n-6 | 0.06 | 0.08 | 0.08 | 0.06 | 0.09 |
| 22:5 n-3 (DPA) | 0.11 | 0.16 | 0.15 | 0.15 | 0.05 |
| 22:6 n-3 (DHA) | 0.00 | 0.00 | 0.00 | 0.00 | 0.00 |
| 24:1 n-9 | 0.00 | 0.00 | 0.00 | 0.00 | 0.00 |
| Total saturates | 31.02 | 29.93 | 31.37 | 31.09 | 29.85 |
| Total monoenes | 51.70 | 54.37 | 50.95 | 53.35 | 54.08 |
| Total n-6 | 11.93 | 10.11 | 11.63 | 9.47 | 11.02 |
| Std Dev (Total n-6) | 0.11 | 0.14 | 0.08 | 0.04 | 0.10 |
| Total n-3 | 0.94 | 1.17 | 1.63 | 1.67 | 0.62 |
| Total PUFA | 12.87 | 11.29 | 13.26 | 11.14 | 11.64 |
| n-6/n-3 | 12.69 | 8.64 | 7.13 | 5.67 | 17.78 |

¹Total fat (g) per 100 g fresh tissue was 17.7, 21.7, 18.5, 16.5, and 14.8
for the 0.2% SDA, 0.4% SDA, 0.6% SDA, 0.8% SDA and Control,
respectively.

Feeding SDA to pigs for the last 35 days prior to slaughter resulted in a significant increase in omega 3 fatty acid enrichment in belly, loin, ham and skin tissues as compared to the control. SDA, ETA, and EPA were enriched in belly, loin, ham, and skin tissues in a dose dependent manner. DPA was enriched in loin and ham tissues in a dose dependent manner. DHA was enriched in ham in a dose dependent manner. The SDA supplementation results in higher levels of SDA, ETA, EPA, DPA in belly, loin, ham and skin tissues and DHA in ham tissue as compared to the control.

While all of the unique fatty acid compositions described in Table 6 above are considered characteristics of embodiments of this invention, Table 7 highlights ratios which may also be used to characterize the unique aspects of embodiments of this invention.

TABLE 7
Fatty Acid Ratios of Pork Products (ratios of concentrations based on g FA per 100 g fat)

| | Sample | SDA/Total | | | | | | |
|---|---|---|---|---|---|---|---|---|
| Feed | Type | SDA/GLA | SDA/ALA | SDA/AA | Saturates | SDA/n6 | EPA/SDA | DHA/SDA |
| 0.2% SDA | Belly | 2.694 | 0.217 | 0.475 | 0.003 | 0.009 | 0.043 | 0.021 |
| 0.4% SDA | Belly | 4.783 | 0.616 | 1.466 | 0.008 | 0.026 | 0.010 | 0.000 |
| 0.6% SDA | Belly | 5.108 | 0.800 | 1.683 | 0.009 | 0.035 | 0.217 | 0.000 |
| 0.8% SDA | Belly | 7.103 | 1.474 | 3.556 | 0.018 | 0.070 | 0.175 | 0.001 |
| Control (corn oil) | Belly | 0.000 | 0.000 | 0.000 | 0.000 | 0.000 | —¹ | — |
| 0.2% SDA | Ham | 0.447 | 0.174 | 0.018 | 0.001 | 0.003 | 4.904 | 2.449 |
| 0.4% SDA | Ham | 0.364 | 0.131 | 0.018 | 0.001 | 0.003 | 6.759 | 2.194 |
| 0.6% SDA | Ham | 1.190 | 0.726 | 0.062 | 0.005 | 0.012 | 3.304 | 0.601 |
| 0.8% SDA | Ham | 1.133 | 0.933 | 0.076 | 0.007 | 0.015 | 3.672 | 0.550 |
| Control (corn oil) | Ham | 0.000 | 0.000 | 0.000 | 0.000 | 0.000 | — | — |
| 0.2% SDA | Loin | 0.045 | 0.015 | 0.002 | 0.000 | 0.000 | — | — |
| 0.4% SDA | Loin | 0.776 | 0.269 | 0.041 | 0.001 | 0.005 | 3.499 | 0.040 |
| 0.6% SDA | Loin | 1.480 | 0.590 | 0.086 | 0.003 | 0.012 | 2.360 | 0.648 |
| 0.8% SDA | Loin | 1.356 | 0.760 | 0.080 | 0.003 | 0.014 | 3.154 | 0.049 |
| Control (corn oil) | Loin | 0.000 | 0.000 | 0.000 | 0.000 | 0.000 | — | — |
| 0.2% SDA | Skin | 1.510 | 0.097 | 0.162 | 0.002 | 0.004 | 0.367 | 0.081 |
| 0.4% SDA | Skin | 3.921 | 0.291 | 0.464 | 0.004 | 0.012 | 0.177 | 0.000 |
| 0.6% SDA | Skin | 4.304 | 0.536 | 1.070 | 0.009 | 0.024 | 0.259 | 0.000 |
| 0.8% SDA | Skin | 5.087 | 0.785 | 1.249 | 0.011 | 0.036 | 0.269 | 0.000 |
| Control (corn oil) | Skin | 0.000 | 0.000 | 0.000 | 0.000 | 0.000 | — | — |

¹The horizontal lines above indicate values below detection limits in the denominator of the ratio.

### REFERENCES

The references cited in this application, both above and below, are specifically incorporated herein by reference.
1. Allen, P. C. and H. D. Danforth. (1998), Effects of Dietary Supplementation with n-3 Fatty Acid Ethyl Esters on Coccidiosis in Chickens, POULTRY SCIENCE 77:1631-1635.
2. Ajuyah, A. O. et al., (1991), Changes in the Yield and in the Fatty Acid Composition of Whole Carcass and Selected Meat Portions of Broiler Chickens Fed Full-Fat Oil Seeds. POULTRY SCIENCE, 70:2304-2314.
3. Arachchige Premakumara G.; et al., (2006), Dietary Sesamin and Docosahexaenoic and Eicosapentaenoic Acids Synergistically Increase the Gene Expression of Enzymes Involved in Hepatic Peroxisomal Fatty Acid Oxidation in Rats. METAB. CLIN. EXP., 55:381-90.
4. Calder, P. C. and Field, C. J. (2002). Fatty Acids, Inflammation and Immunity. IN: NUTRITION AND IMMUNE FUNCTION, (P. C. Calder, C. J. Field and H. S. Gill (Eds)). CABI Publishing. pp: 57-92.
5. Cherian, G. and J. S. Sim. (1995). Dietary α-linilenic acid alters the fatty acid composition of lipid classes in swine tissues. J. AGRICULTURAL FOOD CHEMISTRY 43:2911-16.
6. Enser, M., et al., (2000). Feeding Linseed to Increase the N-3 PUFA of Pork: Fatty Acid Composition of Muscle, Adipose Tissue, Liver And Sausages. MEAT SCIENCE 55:201-12.
7. Harris W S, et al., (2007) Stearidonic Acid Increases the Red Blood Cell and Heart Eicosapentaenoic Acid Content in Dogs, Lipids 42:325-33.
8. James, M. J., Ursin V. M., and Cleland L. G. (2003) Metabolism of stearidonic acid in human subjects: comparison with the metabolism of other n-3 fatty acids. AM J CLIN NUTR 2003; 77: 1140-5.
9. Jaturasitha, S., et al., (2002). Enrichment of pork with omega-3 fatty acids by tuna oil supplements: Effects on performance as well as sensory, nutritional and processing properties of pork. ASIAN-AUSTRALASIAN JOURNAL OF ANIMAL SCIENCE 15:1622-1633.
10. Jρrgensen, H., et al., (1996). The Influence of Rapeseed Oil on Digestibility, Energy Metabolism and Tissue Fatty Acid Composition in Pigs. ACTA AGRIC. SCAND. SECT. A, ANIMAL SCI. 46:65-75.
11. Klasing, K. C. and Leshchinsky, T. V., (2000), Interactions between Nutrition and Immunity. Lessons from Animal Agriculture. IN: NUTRITION AND IMMUNOLOGY: PRINCIPLES AND PRACTICE. (M. E. Gershwin, J. B. German, C. L. Keen (Eds)). Elsevier. pp: 363-73.
12. Kouba, M., et al., (2003). Effect of a High-Linolenic Acid Diet on Lipogenic Enzyme Activities, Fatty Acid Composition, and Meat Quality in the Growing Pig. JOURNAL OF ANIMAL SCIENCE 81:1967-1979.
13. Krasicka, B. et al., (2000). Body Gains and Fatty Acid Composition in Carcasses of Broilers Fed Diets Enriched with Full-Fat Rapeseed and/or Flaxseed, ARCH. GEFLUGELK., 64:61-69.
14. Krokhan H E, et al., (1993). The Enteral Bioavailability of Eicosapentaenoic Acid And Docosahexaenoic Acid is as Good From Ethyl Esters as From Glyceryl Esters in Spite of Lower Hydrolytic Rates by Pancreatic Lipase In Vitro. BIOCHIM BIOPHYS ACTA, 20; 1168(1):59-67.
15. Leskanich, C. O., et al., (1997). The Effect of Dietary Oil Containing (N-3) Fatty Acids on the Fatty Acid, Physicochemical, and Organoleptic Characteristics of Pig Meat and Fat. J. ANIM. SCI. 75:673-83.
16. Lôpez-Ferrer, S. et al, (2001). (n-3 enrichment of chicken meat.) Use of Precursors of Long-Chain Polyunsaturated Fatty Acids in Linseed Oil, POULTRY SCIENCE 80:753-761.
17. Marriott, N. G., et al., (2002). Performance Characteristics and Fatty Acid Composition of Pigs Fed a Diet with Docosahexaenoic Acid. JOURNAL OF MUSCLE FOODS 13:265-77.
18. Martínez M. et al., (2000), Therapeutic effects of docosahexaenoic acid ethyl ester in patients with generalized peroxisomal disorders. AMERICAN JOURNAL OF CLINICAL NUTRITION, Vol. 71, No. 1, 376S-385S.
19. Matthews, K. R., et al., (2000). Effect of whole linseed (Linum usitatissimum) in the diet of finishing pigs on growth performance and on the quality and fatty acid composition of various tissues. BRITISH JOURNAL OF NUTRITION 83:637-643.
20. Mattos R., C R Staples, and W W Thatcher, Effects of Dietary Fatty Acids on Reproduction in Ruminants, (2000), REVIEWS OF REPRODUCTION 5:38-45.
21. Miles E A, Banerjee T. and Calder, P. C. (2004), The Influence of Different Combinations of Gamma-Linolenic Acid, Stearidonic Acid and EPA on Immune Function in Healthy Young Male Subjects. BR J NUTR. 91(6):893-903.
22. Morgan, C., et al., (1992). Manipulation of the fatty acid composition of pig meat lipids by dietary means. J. SCI. FOOD AGRIC. 58:357-368.
23. Napier, Johnathan. (2007) The Production of Unusual Fatty Acids in Transgenic Plants. ANN. REV. PLANT BIOL., 2007 58:295-319.
24. Otten, W., et al., (1993). A High Omega 3 Fatty Acid Diet Alters Fatty Acid Composition of Heart, Liver, Kidney, Adipose Tissue and Skeletal Muscle in Swine. ANN. NUTR. METAB. 37:134-41.
25. Nurnberg, K. U., et al., (1999). Influence of Exogenous Application of n-3 Fatty Acids on Meat Quality, Lipid Composition, and Oxidative Stability in Pigs. ARCH. ANIM. NUTR. 52:53-65.
26. Specht-Overholt, S., et al., (1997). Fatty Acid Composition of Commercially Manufactured Omega-3 Enriched Pork Products, Haddock, and Mackerel. J. ANIM. SCI. 75:2335-2343.
27. Sun-Young Lim and Hiramitsu Suzuki. (2000), Intakes of Dietary Docosahexaenoic Acid Ethyl Ester and Egg Phosphatidylcholine Improve Maze-Learning Ability in Young and Old Mice. JOURNAL OF NUTRITION. 130:1629-32.
28. Ursin G. et al., (2003), Modification of Plant Lipids for Human Health: Development of Functional Land-Based Omega-3 Fatty Acids. J. NUTR. 133:4271-74.

What is claimed is:

1. A pork product for human consumption comprising stearidonic acid (SDA) and wherein the concentration of said SDA is at least about 0.05 g per 100 g of fat in the pork product and wherein a portion of said SDA is incorporated in the tissues of said pig after said pig is provided a feed composition containing SDA.

2. The pork product of claim 1, further comprising DHA wherein the DHA is at least about 0.03 g per 100 g of fat in the pork product.

3. The pork product of claim 1, further comprising EPA wherein the EPA is at least about 0.01 g per 100 g fat in the pork product.

4. The pork product of claim 1, further comprising GLA wherein the GLA concentration is at least about 0.01 g per 100 g of fat in the pork product.

5. The pork product of claim 1 further comprising ALA wherein the ratio of SDA/ALA concentration is at least about 0.1.

6. The pork product of claim 1 further comprising tocochromanol.

7. The pork product of claim 6 wherein said pork product comprises at least about 10 ppm tocochromanol.

8. The pork product of claim 7 wherein tocochromanol is a tocopherol.

9. The pork product of claim 1 wherein said pork product is selected from the group consisting of bacon, ham, pork loin, pork ribs, pork steaks, lard, pork rinds or other pork products.

10. The pork product of claim 1, wherein said pork product comprises pork meat.

11. The pork product of claim 1, wherein the ratio of SDA/GLA is at least about 1.0.

12. The pork product of claim 3, wherein the ratio of EPA/SDA is at least about 0.1.

13. The pork product of claim 2, wherein the ratio of DHA/SDA is at least about 0.1.

14. A method of producing pigs comprising:
a. providing a nutritious composition comprising stearidonic acid (SDA) as a feed source for said pigs;
b. feeding said nutritious composition to at least one pig; and
c. producing progeny from said at least one pig;
wherein said nutritious composition comprises at least about 0.01% SDA.

15. The method according to claim 14, wherein said nutritious composition comprises seeds selected from the group consisting of soybeans, safflower, sunflower, canola, and corn.

16. The method according to claim 14, wherein the reproductive performance of said at least one pig is enhanced.

17. The method according to claim 14, wherein the nutritious composition further comprises GLA, and wherein the ratio of concentrations of SDA/GLA is at least about 2.

18. The method of claim 14, wherein the omega-3 to omega-6 fatty acid ratio of the nutritious composition is greater than about 2:1.

19. The method of claim 14, wherein said nutritious composition further comprises 6-cis, 9-cis, 12-cis, 15-trans-octadecatetraenoic acid.

20. The method of claim 14, wherein said nutritious composition further comprises 9-cis, 12-cis, 15-trans-alpha linolenic acid.

21. The method of claim 14, wherein said nutritious composition further comprises 6, 9-octadecadienoic acid.

22. The method of claim 14, wherein said nutritious composition further comprises ingredients selected from the group consisting of salt, antibiotics, corn, wheat, oats, barley, soybean meal, cottonseed meal, flaxseed meal, canola meal, wheat middlings, wheat bran, rice bran, corn distiller dried grains, corn gluten meal, corn gluten feed, molassess, rice mill byproduct, corn oil, flax oil, soy oil, palm oil, animal fat, restaurant grease, antioxidants, tocochromanols, tocopherols, vitamins, minerals, amino acids, and coccidostats.

23. A pork meat product for human consumption comprising stearidonic acid (SDA), and eicosapentaenoic acid (EPA), wherein:
a. the concentration of said SDA is at least about 0.01 g per 100 g fat in the pork meat product; and
b. the concentration of said EPA is at least about 0.01 g per 100 g fat in the pork meat product.

24. The pork meat product of claim 23 further comprising GLA, wherein the ratio of SDA/GLA concentrations is at least about 2.

25. The pork meat product of claim 23 further comprising ALA wherein the ratio of SDA/ALA concentrations is at least about 0.1.

26. The pork product of claim 23, wherein the ratio of EPA/SDA is at least about 0.1.

27. The pork meat product of claim 23 further comprising DHA.

28. The pork meat product of claim 23, wherein the SDA content is at least about 0.05 g per 100 g fat.

29. A method of producing a pork product for human consumption comprising:
a. providing a stearidonic acid source comprising stearidonic acid (SDA) as a component of feed for pigs;
b. providing additional feed components for said pig feed composition;
c. combining said stearidonic acid source with said feed components to make a supplemented feed;
d. feeding said supplemented feed to a plurality of pigs;
e. harvesting at least one edible product for human consumption from said pigs;
wherein said stearidonic acid source comprises a transgenic plant source; and,
wherein at least a portion of said SDA is incorporated into said edible product after the feeding of said plurality of pigs said SDA.

30. The method according to claim 29, wherein said stearidonic acid source comprises seeds selected from the group consisting of soybeans, safflower, sunflower, canola, and corn.

31. The method according to claim 29, wherein the stearidonic acid source comprises less than about 30% of the total fatty acids in said stearidonic acid source.

32. The method according to claim 29, wherein said pork product has incorporated EPA, DHA and/or DTA into their tissues as a result of said plurality of pigs being fed stearidonic acid.

33. The method according to claim 29, wherein said stearidonic acid source further comprises tocochromanol.

34. The method of claim 33, wherein said stearidonic acid source comprises at least about 10 ppm of tocochromanol.

35. The method of claim 34, wherein said tocochromanol is tocopherol.

36. The method of claim 29, wherein the omega-3 to omega-6 fatty acid ratio of the stearidonic acid source is greater than about 2:1.

37. The method of claim 29, wherein said stearidonic acid source further comprises 6-cis, 9-cis, 12-cis, 15-trans-octadecatetraenoic acid.

38. The method of claim 29, wherein said stearidonic acid source further comprises 9-cis, 12-cis, 15-trans-alpha linolenic acid.

39. The method of claim 29, wherein said stearidonic acid source further comprises 6, 9-octadecadienoic acid.

40. The method of claim 29, wherein said additional feed component comprises ingredients selected from the group consisting of salt, antibiotics, corn, wheat, oats, barley, soybean meal, cottonseed meal, flaxseed meal, sunflower meal, canola meal, wheat middlings, wheat bran, rice bran, corn distiller dried grains, corn gluten meal, corn gluten feed, molassess, rice mill byproduct, corn oil, flax oil, soy oil, palm oil, animal fat, restaurant grease, antioxidants, tocochromanols, tocopherols, vitamins, minerals, amino acids, and coccidostats.
